(19) United States
(12) Patent Application Publication
(10) Pub. No.: US 2023/0364685 A1
(43) Pub. Date: Nov. 16, 2023

(54) Toolholder and cutting tool

(71) Applicant: KENNAMETAL INC., Latrobe, PA (US)

(72) Inventor: Konrad Spitzenberger, Fuerth (DE)

(21) Appl. No.: 18/196,243

(22) Filed: May 11, 2023

(30) Foreign Application Priority Data
May 12, 2022 (DE) 102022111974.2

(51) Int. Cl. B23B 27/16; B33Y 80/00

(52) U.S. Cl. CPC B23B 27/1666; B33Y 80/00; B23B 2205/00

(57) ABSTRACT

A toolholder has a plurality of receptacles for at least one respective cutting insert. For each receptacle, the toolholder comprises a clamping element associated with the receptacle and a hydraulic channel associated with the corresponding clamping element. Each clamping element is hydraulically adjustable between a closed position and an opened position via the associated hydraulic channel. Furthermore, the toolholder is configured such that the clamping elements in the closed position clamp the associated cutting inserts into the corresponding receptacle for the cutting operation and thus fix them to the toolholder and release them in the opened position so that the cutting inserts can be detached from the toolholder, in particular in a tool-free manner. Furthermore, a cutting tool is provided having a toolholder according to any one of the preceding claims and at least one cutting insert.

### RELATED APPLICATION DATA

The present application claims priority pursuant to 35 U.S.C. § 119(a) to German Patent Application Number 102022111974.2 filed May 12, 2022 which is incorporated herein by reference in its entirety.

### FIELD

The invention relates to a toolholder having a plurality of receptacles for a respective cutting insert, wherein for each receptacle the toolholder comprises a clamping element associated with the receptacle. The invention further relates to a cutting tool having such a toolholder and at least one cutting insert.

### BACKGROUND

Such toolholders as well as cutting tools having such a toolholder are known.

The toolholders comprise a plurality of receptacles in which cutting inserts can be mounted for the cutting operation. Thus, the cutting inserts can be individually replaced when worn. Typically, these cutting inserts are clamped in the receptacles by means of clamping elements, for example by means of tensioning screws, which push and thus fix the cutting inserts against the receptacle.

A disadvantage with these toolholders is the number of tensioning screws that need to be tightened or loosened in order to secure or replace the cutting inserts.

The problem addressed by the invention is to provide a toolholder as well as a cutting tool having such a toolholder, to which cutting inserts can be fastened and replaced with little effort.

### SUMMARY

The problem is solved by a toolholder having a plurality of receptacles for at least one respective cutting insert. For each receptacle, the toolholder comprises a clamping element associated with the receptacle and a hydraulic channel associated with the corresponding clamping element. Each clamping element is hydraulically adjustable between a closed position and an opened position via the associated hydraulic channel. Furthermore, the toolholder is configured such that the clamping elements in the closed position clamp the associated cutting inserts into the corresponding receptacle for the cutting operation and thus fix them to the toolholder and release them in the opened position so that the cutting inserts can be detached from the toolholder, in particular in a tool-free manner.

According to the present invention, it has been found that, compared to tensioning screws that individually must be tightened or loosened with a wrench or screwdriver, hydraulically adjustable clamping elements are reliably adjustable between a closed position and an opened position with little effort. For this purpose, only the pressure in the corresponding hydraulic channel must be adjusted to a value that corresponds to the closed position or the opened position. By releasing the cutting inserts in the opened position, as a result of which they are no longer fastened, in particular no longer rigidly fastened, the cutting inserts can be removed from the receptacles with low force, for example by hand. In other words, the cutting inserts are loosely connected to the toolholder so that no tool is required in order to separate the cutting inserts from the toolholder. In particular, the cutting inserts are not connected to the toolholder in a wedged or self-inhibited manner in the opened position, so that they would have to be released from the toolholder with great force, for example by means of a hammer.

In one embodiment, the hydraulic channels are part of a hydraulic system and are fluidly connected to one another. In this way, all clamping elements can be adjusted simultaneously or in parallel by setting the pressure inside the hydraulic system to a corresponding value. Thus, all clamping elements are adjusted to the open or closed position together, thus clamping or releasing all cutting inserts together, thereby further reducing the cost of fastening or replacing the cutting inserts.

The toolholder can have a filling opening for filling the hydraulic system. The filling opening is arranged on a front face of the toolholder, which is provided so as to oppose a prime mover when the toolholder is mounted to the prime mover for the cutting operation. In the mounted position, the front face is thus at least partially obscured by the prime mover, and the filling opening is arranged in a location that is not accessible or difficult to access. In this way, it can be reliably prevented that the hydraulic fluid is supplied to or removed from the hydraulic system via the filling opening when the toolholder is fastened to the prime mover. Thus, the operational safety is increased.

In a further embodiment, the toolholder has an adjustment element by means of which the pressure of the hydraulic system can be adjusted. This design has the advantage that the pressure inside the hydraulic system can be effectively and precisely adjusted via the adjustment element.

Here, it can be provided that the adjustment element can be adjusted between a first position in which the clamping elements are in the opened position and a second position in which the clamping elements are in the closed position. Thus, the clamping elements can be adjusted together via the adjustment element with little effort between the opened position and the closed position.

Additionally, or alternatively, the adjustment element can be arranged on a side of the toolholder that is provided so as to not oppose a prime mover when the toolholder is mounted on the prime mover for the cutting operation. In the mounted position, the side with the adjustment element is thus not obscured by the prime mover and is therefore easily accessible. In this way, the cutting inserts can be clamped or released via the adjustment element without the need to disassemble the toolholder from the prime mover. Thus, it is possible to replace cutting inserts with little effort even when the toolholder is mounted on the prime mover for the cutting operation.

According to one embodiment, the clamping elements are plungers, each of which is slidably supported in a cylinder recess. This design has the advantage that the clamping elements are reliably and precisely hydraulically adjustable between the closed position and the opened position.

Further, for each clamping element, the toolholder can comprise a resetting element associated with the corresponding clamping element, which biases the associated clamping element into the opened position or the closed position, depending on which position is desired as the home position. Thus, it is ensured that the clamping element is pushed by the resetting element into the opened position or the closed position, respectively, when the hydraulic pressure is less than the spring force.

According to a further embodiment, the toolholder is manufactured by means of an additive manufacturing process, in particular by means of a 3D printing process. In this way, the toolholder can be manufactured with little effort. In particular, the internal hydraulic channels can be efficiently formed using this manufacturing process.

According to the invention, a cutting tool with a toolholder according to the invention having the aforementioned advantages and at least one cutting insert is also provided in order to solve the aforementioned problem.

### BRIEF DESCRIPTION OF THE DRAWINGS

Further advantages and features will emerge from the following description and from the accompanying drawings. The figures show:

FIG. 1 in a side view, a cutting tool according to the invention with a toolholder according to the invention and a plurality of cutting inserts,

FIG. 2 in a plan view, the cutting tool from FIG. 1,

FIG. 3 the cutting tool in a sectional view along the plane C-C in FIG. 1,

FIG. 4 the cutting tool in a sectional view along the plane B-B in FIG. 1,

FIG. 5 the cutting tool in a sectional view along the plane A-A in FIG. 1 in a closed position in which the cutting inserts are fixed,

FIG. 6 the cutting tool in a sectional view along the plane A-A in FIG. 1 in an opened position in which the cutting inserts are released,

FIG. 7 the cutting tool according to a further embodiment in a sectional view along the plane A-A in FIG. 1 in a closed position in which the cutting inserts are fixed, and

FIG. 8 the cutting tool according to the further embodiment in a sectional view along the plane A-A in FIG. 1 in an opened position in which the cutting inserts are released.

### DETAILED DESCRIPTION

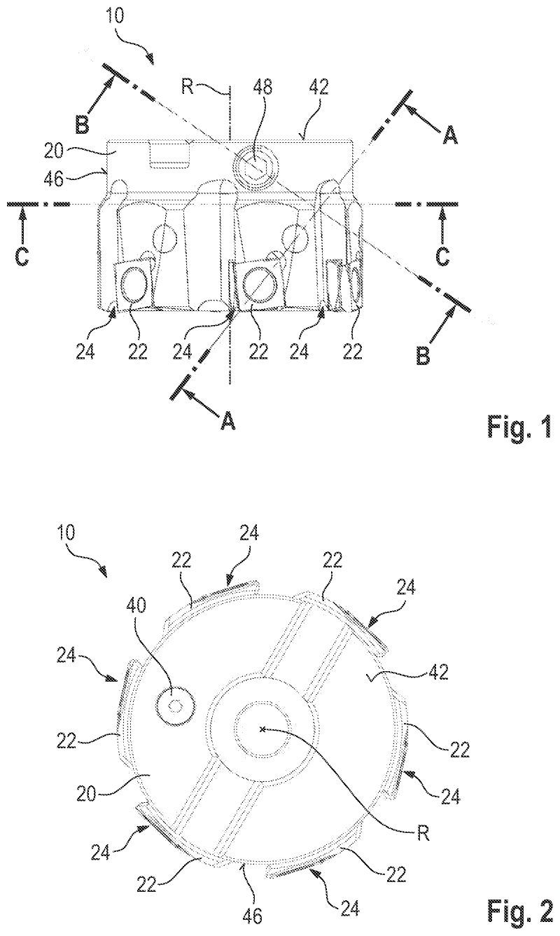

In FIG. 1, a cutting tool 10 is shown with a toolholder 20 and a plurality of cutting inserts 22, each arranged in a receptacle 24 of the toolholder 20.

The toolholder 20 is manufactured by means of an additive manufacturing process, for example by means of a 3D printing process.

In the illustrated embodiment, the cutting tool 10 is a turntable mill having six receptacles 24 (see FIG. 2) for six respective cutting inserts 22 and an axis of rotation R about which the turntable mill rotates in the cutting operation.

Generally, the cutting tool 10 can be any cutting tool, in particular any rotating cutting tool.

Additionally or alternatively, in an alternative embodiment, the cutting tool 10 can comprise any number of receptacles 24, but at least two.

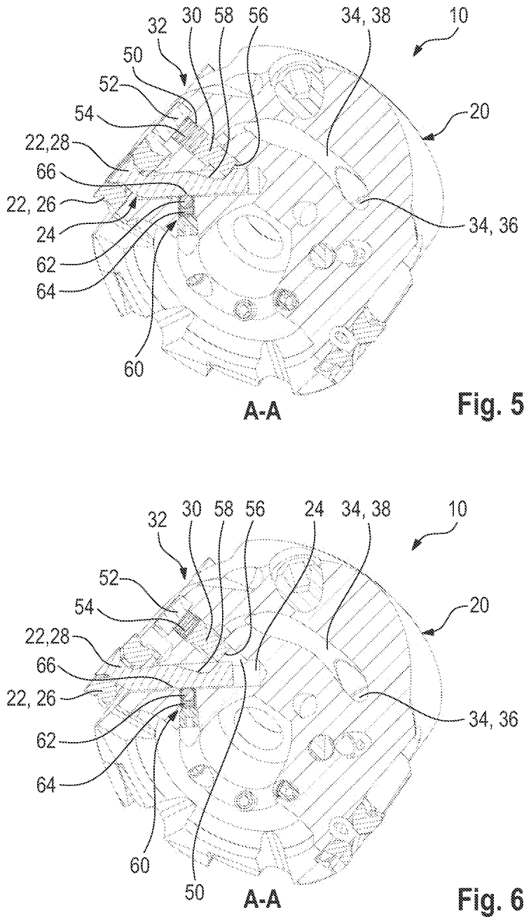

The cutting inserts 22 each have a cutting body 26 (see FIG. 5), which is configured for machining a workpiece, and a tensioning element 28, by means of which the cutting body 26 is fastened to the toolholder 20.

To fasten the cutting inserts 22, the toolholder 20 has six clamping elements 30, each associated with a respective receptacle 24 and configured so as to clamp the tensioning element 28 arranged in the corresponding receptacle 24, as will be explained in further detail below.

In an alternative embodiment, more than one cutting insert 22 can be arranged in each receptacle 24, which can be clamped together for fastening by the clamping element 30 associated with the receptacle 24.

The cutting inserts 26 in the present embodiment are indexable inserts, and the tensioning elements 28 are tensioning bolts.

In principle, the cutting body 26 and the tensioning elements 28 can each be designed as desired.

In an alternative embodiment, the cutting inserts 22 do not have separate tensioning elements 28. In this case, the clamping elements 30 are respectively configured so as to clamp the corresponding cutting body 26 directly or via an integral piece in the associated receptacle 24 with a clamping element 28 connected to the cutting body 26.

The clamping elements 30 are each part of a clamping mechanism 32 that is associated with the corresponding receptacle 24 and hydraulically actuatable.

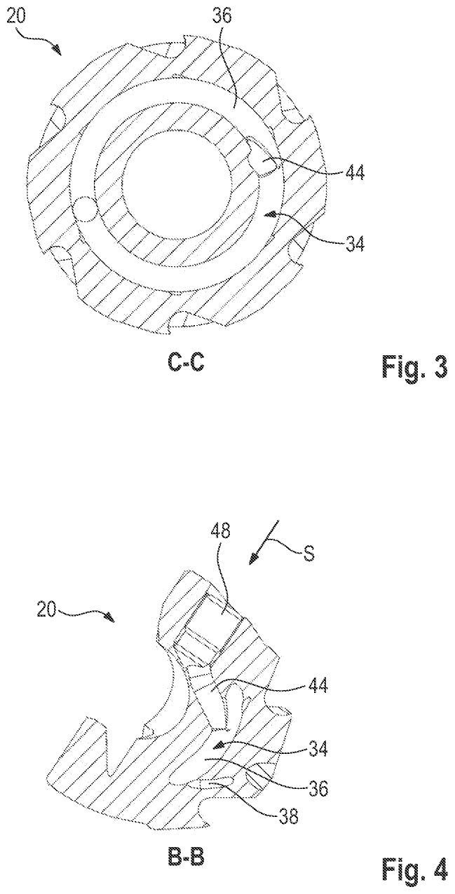

For this purpose, the toolholder 20 comprises a hydraulic system 34 having a preferably annular reservoir 36 (see FIG. 3), as well as six hydraulic channels 38, each associated with a clamping mechanism 32 and fluidly connected to the reservoir 36.

In operation, the hydraulic system 34 is filled with a hydraulic fluid that can be supplied to or removed from the hydraulic system 34 via a filling opening 40 (see FIG. 2).

The filling opening 40 is arranged on a front face 42 of the toolholder 20, which opposes a prime mover (not shown) when the toolholder 20 is fastened to the prime mover for the cutting operation.

Furthermore, the hydraulic system 34 has an adjustment channel 44 (see FIG. 4) extending from the reservoir 36 to a circumferential side 46 of the toolholder 20 and in which an adjustment element 48 of the toolholder 20 is arranged.

In the present embodiment, the adjustment element 48 is a compression screw, which can be screwed into the adjustment channel 44 in an adjustment direction S, in order to increase the force with which the adjustment element 48 presses on the hydraulic fluid in the hydraulic system 34, and thus to increase the pressure in the hydraulic system 34, or which can be released counter to the adjustment direction S, in order to reduce the force with which the adjustment element 48 presses on the hydraulic fluid in the hydraulic system 34, and thus to lower the pressure in hydraulic system 34.

Unlike the front face 42, the circumferential side 46 does not lie opposite the prime mover when the toolholder 20 is fastened to the prime mover for the cutting operation. Thus, the adjustment element 48 is also accessible on the prime mover in the assembled state of the toolholder 20.

The clamping mechanisms 32 are designed so as to be substantially identical to one another. Thus, the construction and function of the clamping mechanisms 32 will be exemplified below using a clamping mechanism 32 and with reference to FIGS. 5 and 6.

The clamping mechanism 32 has a cylinder recess 50 in which the clamping element 30 is axially slidably supported and opens into the receptacle 24 with one axial end.

At the opposite axial end, the cylinder recess 50 is closed by a plug 52.

Between the plug 52 and the clamping element 30, a biasing element 54 is arranged in the form of a spiral spring, which elastically biases the clamping element towards the receptacle 24.

The hydraulic channel 38 associated with the clamping mechanism 32 opens into the cylinder recess 50 and is configured so as to hydraulically adjust the clamping element 30 in the axial direction.

In order to ensure that hydraulic fluid remains in the hydraulic system 34 during operation and does not escape into receptacle 24 via the cylinder recess 50, the clamping mechanism 32 can comprise a sealing device, such as a piston washer.

In this context, the clamping element 30 forms a plunger that can be adjusted between a closed position (see FIG. 5), in which an axial end 56 of the clamping element 30 projects into the receptacle 24 and clamps the cutting insert 22 in the receptacle 24, and an opened position (see FIG. 6) in which the clamping element 30 releases the cutting insert 22 so that it can be removed from the receptacle 24 and thus separated from the toolholder 20.

In the present embodiment, the closed position is defined by a low pressure level in the hydraulic system 34, such that the spring force of the resetting element 54 is sufficient in order to press the clamping element 30 against the cutting insert 22 in the receptacle 24 counter to the hydraulic pressure.

The axial end 56 engages with a notch 58 in the tensioning element 28 and thus abuts the tensioning element 28, whereby the cutting insert 22 is reliably clamped and fixed to the toolholder 20.

The opened position is defined by a high pressure level in the hydraulic system 34, which is large enough for the clamping element 30 to compress the resetting element 54 and thus be adjusted towards the plug 52.

In order to prevent the cutting insert 22 from falling out of the receptacle 24 in the opened position due to its own weight, the toolholder 20 comprises a retaining device 60 associated with the receptacle 24, which holds the cutting insert 22 in the receptacle 24 under a bias.

For this purpose, the retaining device 60 has a pressure piece 62 in the form of a ball and an elastic element 64 in the form of a spiral spring, which pushes the pressure piece 62 against the cutting insert 22 with low pressure.

The tensioning element 28 here has a position notch 66, with which the pressure piece 62 can engage in order to keep the tensioning element 28 in a defined position.

The position notch 66 is preferably positioned such that the tensioning element 28 is arranged in the receptacle 24 when the pressure piece 62 engages with the position notch 66, such that the cutting insert 22 is reliably fixed when the clamping element 30 is adjusted from the opened position into the closed position.

In order to fasten the cutting inserts 22 to the toolholder 20, the clamping elements 30 are initially adjusted together into the opened position in that the hydraulic pressure is increased by setting the adjustment element 48 to the high pressure level.

The position which the adjustment element 48 occupies in the opened position of the clamping elements 30 defines a first position of the adjustment element 48.

Subsequently, the cutting inserts 22 are inserted into the receptacles 24 in which they are held in position by means of the retaining devices 60.

Finally, the clamping elements 30 are adjusted together into the closed position, in that the hydraulic pressure is reduced by setting the adjustment element 48 to the low pressure level.

The position which the adjustment element 48 occupies in the closed position of the clamping elements 30 defines a second position of the adjustment element 48.

In this way, all cutting inserts 22 are effectively clamped in the receptacles 24 and thus securely fastened to the toolholder 20 for the cutting operation.

In this context, it is advantageous to have a display associated with the adjustment element 48 which marks the first and second positions, such that the adjustment element 48 can be reliably set to these positions.

Additionally, or alternatively, the toolholder 20 can comprise a pressure display indicating the hydraulic pressure in the hydraulic system 34, in particular the high pressure level and the low pressure level to which the opened or closed position is associated.

In order to separate the cutting inserts 22 from the toolholder 20 again, the clamping elements 30 are adjusted together to the opened position in that the adjustment element 48 is reset to the first position.

As a result, the cutting inserts 22 are no longer clamped in the receptacles 24, but are merely held in the receptacles 24 by the retaining devices 60 such that the cutting inserts 22 can be removed from the receptacles 24 with little force by hand and thus without tools.

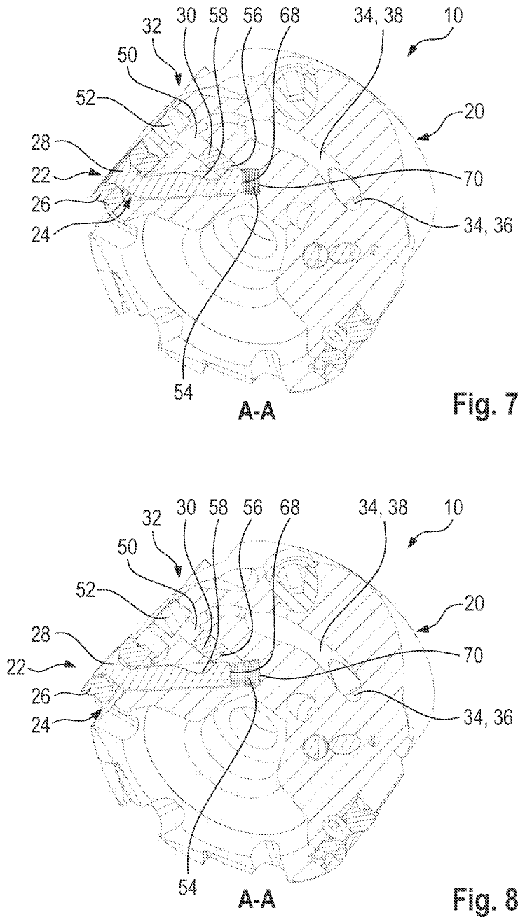

A cutting tool according to a second embodiment will now be described based on FIGS. 7 and 8. For the components known from the above embodiment, the same reference numerals are used, and reference is made in this respect to the foregoing explanations.

By contrast to the embodiment shown in FIGS. 5 and 6, in which the clamping elements 30 are in the opened position when the hydraulic pressure is at the high pressure level, and in the closed position when the hydraulic pressure is at the low pressure level, the clamping mechanisms 32 of the toolholder 20 are designed according to the second embodiment such that the clamping elements 30 are in the closed position when the hydraulic pressure is at the high pressure level and in the opened position when the hydraulic pressure is at the low pressure level.

The hydraulic channels 38 here respectively open into the cylinder recess 50 between the associated clamping element 30 and the plug 52, such that the clamping element 30 is pushed towards the receptacle 24 by the hydraulic pressure.

In this context, the resetting elements 54 are arranged so as to bias the clamping elements 30 into the opened position.

In the present embodiment, the resetting elements 54 are arranged in receptacle 24 between a front face 68 of the tensioning element 28 and an opposing wall 70 of the receptacle 24 when the cutting inserts 22 are inserted into the receptacle 24.

Thus, the resetting elements 54 push the tensioning element 28 away from the wall 70 and the clamping element 30 away from the receptacle 24, respectively.

Furthermore, according to the second embodiment, the toolholder 20 has no retaining devices 60.

Of course, according to an alternative embodiment, the toolholder 20 can have corresponding retaining devices 60.

In all embodiments, in this manner, a toolholder 20 as well as a cutting tool 10 with a toolholder 20 is provided, to which cutting inserts 22 can be fastened and replaced with little effort.

The hydraulic system 34 ensures that all clamping elements 30 are reliably adjustable between the closed and the opened positions together via a single adjustment element 48.

The invention is not limited to the embodiments shown. Individual features of one embodiment can in particular be combined as desired with features of other embodiments, in particular independently of the other features of the corresponding embodiments.

### LIST OF REFERENCE NUMERALS

10 Cutting tool
20 Toolholder
22 Cutting inserts
24 Receptacle
26 Cutting body
28 Tensioning element
30 Clamping element
32 Clamping mechanism
34 Hydraulic system
36 Reservoir
38 Hydraulic channel
40 Filling opening
42 Front face
44 Adjustment channel
46 Circumferential side
48 Adjustment element
50 Cylinder recess
52 Plug
54 Resetting element
56 Axial end
58 Notch
60 Retaining device
62 Pressure piece
64 Elastic element
66 Position notch
68 Front face
70 Wall

1. A toolholder having a plurality of receptacles for at least one respective cutting insert, wherein the toolholder comprises for each receptacle a clamping element associated with the receptacle and a hydraulic channel associated with the corresponding clamping element, wherein each clamping element is hydraulically adjustable between a closed position and an opened position via the associated hydraulic channel, wherein the toolholder is configured such that the clamping elements clamp the associated cutting inserts in the receptacles in the closed position for the cutting operation and thus fix them to the toolholder and release them in the opened position, such that the cutting inserts can be detached from the toolholder.

2. The toolholder according to claim 1, wherein the hydraulic channels are part of a hydraulic system and are fluidly connected to one another.

3. The toolholder according to claim 2, wherein the toolholder comprises a filling opening for filling the hydraulic system, wherein the filling opening is arranged on a front face of the toolholder that is provided so as to oppose a prime mover when the toolholder is mounted on the prime mover for the cutting operation.

4. The toolholder according to claim 1, wherein the toolholder has an adjustment element by means of which the pressure of the hydraulic system can be adjusted.

5. The toolholder according to claim 4, wherein the adjustment element can be adjusted between a first position in which the clamping elements are in the opened position and a second position in which the clamping elements are in the closed position.

6. The toolholder according to claim 4, wherein the adjustment element is arranged on a side of the toolholder that is provided so as to not oppose a prime mover when the toolholder is mounted on the prime mover for the cutting operation.

7. The toolholder according to claim 1, wherein the clamping elements are plungers, each of which is slidably supported in a cylinder recess.

8. The toolholder according to claim 1, wherein the toolholder for each clamping element comprises a resetting element associated with the corresponding clamping element that biases the associated clamping element to the opened position or the closed position.

9. The toolholder according to claim 1, wherein the cutting inserts are detached from the toolholder in a tool-free manner.

10. The toolholder according to claim 1, wherein the toolholder is manufactured by means of an additive manufacturing process.

11. The toolholder according to claim 10, wherein the additive manufacturing process is 3D printing.

12. A cutting tool having a toolholder according to claim 1 and at least one cutting insert (22).
